(19) United States
(12) Patent Application Publication
(10) Pub. No.: US 2012/0268260 A1
(43) Pub. Date: Oct. 25, 2012

(54) METHOD AND APPARATUS FOR DYNAMICALLY PROVIDING SPACE MANAGEMENT ALERTS FOR A VEHICLE

(75) Inventors: Thomas Lee Miller, Ann Arbor, MI (US); Brian Bennie, Sterling Heights, MI (US); Thomas Michael McQuade, Ann Arbor, MI (US); Aaron L. Mills, Ann Arbor, MI (US); Scott Alan Watkins, Sterling Heights, MI (US)

(73) Assignee: FORD GLOBAL TECHNOLOGIES, LLC, Dearborn, MI (US)

(21) Appl. No.: 13/091,474

(22) Filed: Apr. 21, 2011

(51) Int. Cl. B60Q 1/00

(52) U.S. Cl. 340/435

(57) ABSTRACT

In at least one embodiment, an apparatus for providing a space management alert for a host vehicle is provided. The apparatus comprises a controller configured to determine whether a first vehicle positioned ahead of the host vehicle is in a first detection zone and to determine whether a second vehicle positioned on one of a left side and a right side of the host vehicle is in a second detection zone. The controller is further configured to determine that the host vehicle is in a high density traffic condition (HDTC) if the first vehicle is in the first detection zone and the second vehicle is in the second detection zone and to selectively disable a space management alert when the host vehicle is in the HDTC.

### TECHNICAL FIELD

Embodiments described herein generally relate to a method and apparatus for dynamically providing space management alerts for a vehicle.

### BACKGROUND

It is known to implement a notification system that provides alerts to notify a driver that his/her vehicle may be on a path to collide with another vehicle (or obstacle). One example of this type of implementation is set forth directly below.

United States (U.S.) Pat. No. 7,375,620 to Bilbale et al. provides a rear obstacle detection and avoidance system for use on a vehicle. The system comprises a rear obstacle detector that is coupled to the vehicle and measures the distance between the vehicle and an obstacle substantially to the vehicle's rear, a speed sensor that determines vehicle speed, an alert generator that notifies an occupant of the vehicle of a rear obstacle, and a processor that is coupled to the rear obstacle detector, the speed sensor, and the alert generator. The processor causes the generation of a first alert when the vehicle's speed is less than a threshold speed and the distance between the vehicle and an obstacle substantially to the vehicle's rear is less than a first distance determined in accordance with a first function of speed vs. distance. Additionally, the processor causes the generation of a second alert when the vehicle's speed is greater than the threshold speed and the distance between the vehicle and an obstacle substantially to the vehicle's rear is less than a second distance determined in accordance with second function of speed vs. distance.

### SUMMARY

In at least one embodiment, an apparatus and method for providing a space management alert for a host vehicle is provided. The apparatus comprises a controller configured to determine whether a first vehicle positioned ahead of the host vehicle is in a first detection zone and to determine whether a second vehicle positioned on one of a left side and a right side of the host vehicle is in a second detection zone. The controller is further configured to determine that the host vehicle is in a high density traffic condition (HDTC) if the first vehicle is in the first detection zone and the second vehicle is in the second detection zone and to selectively disable a space management alert when the host vehicle is in the HDTC.

In another embodiment, an apparatus comprising a controller is provided. The controller is configured to receive a gap signal indicative of a front gap between a host vehicle and a first vehicle and to determine whether the front gap decreases over a predetermined time period. The controller is further configured to determine that the host vehicle is experiencing a cutoff condition in response to the front gap decreasing over the predetermined time period and to selectively disable transmitting a space management alert if the host vehicle is experiencing a cutoff condition.

### BRIEF DESCRIPTION OF THE DRAWINGS

The embodiments of the present invention are pointed out with particularity in the appended claims. However, other features of the various embodiments will become more apparent and will be best understood by referring to the following detailed description in conjunction with the accompany drawings in which:

FIG. 1 depicts an apparatus for intelligently generating an alert to notify a driver of proper space management with a vehicle or other object in accordance to one embodiment;

FIG. 2 depicts a method for determining when the vehicle is in a high density traffic vehicle environment in accordance to one embodiment;

FIG. 3 depicts a method for determining whether the vehicle is in a cut-off or intentional merge condition in accordance to one embodiment;

FIG. 4 depicts a method for determining whether the driver is in a distracted state in accordance to one embodiment;

FIG. 5 depicts a method for intelligently generating an alert to notify a driver of proper space management with a vehicle or other object in accordance to one embodiment; and

FIG. 6 depicts a method for intelligently generating the alert to notify one of a primary driver and a secondary driver in accordance to one embodiment.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

A system that notifies or warns a driver in a vehicle of proper space management with respect to surrounding vehicles (or obstacles) can generate too many warnings based on the driving environment. If the system generates too many collision warnings where the driver is aware that his/her vehicle is not imminently expected to contact the vehicle, then the driver may learn to ignore these warnings which may defeat the purpose of the space management alert. The embodiments described herein provide a method and apparatus for intelligently generating a space management alert with respect to another vehicle (or object) based on, but not limited to, dynamic driving environment, driver alertness, and driver intent. For example, the embodiments may inhibit such alerts if the vehicle (i) is detected to be in a high density traffic condition, (ii) is being cut-off by another vehicle, and/or (iii) intends to merge into an opening of another lane where other vehicles may be present.

It is contemplated that the embodiments set forth herein may be utilized for purposes other than those described and that challenges or problems noted are not intended to be an exhaustive list of problems that may be overcome by the embodiments of the present invention. Such challenges or problems are noted for illustrative purposes and that all of the challenges or problems that may be overcome by the various embodiments are not described for purposes of brevity. Moreover, it is contemplated that the embodiments may provide for a number of advantages (or benefits) and that those noted are not intended to be an exhaustive list that may be achieved. Such advantages as disclosed are noted for illustrative purposes and that all of the advantages achieved by the embodiments are not described for purposes of brevity as well. Furthermore, the examples provided are disclosed for illustrative purposes and are not intended to limit the scope in any manner.

The embodiments set forth generally illustrate and describe a plurality of controllers (or modules), or other such electrically based components. All references to the various controllers and electrically based components and the functionality provided for each, are not intended to be limited to encompassing only what is illustrated and described. While particular labels may be assigned to the various controllers and/or electrical components disclosed, such labels are not intended to limit the scope of operation for the controllers and/or the electrical components. The controllers may be combined with each other and/or separated in any manner based on the particular type of electrical architecture that is desired or intended to be implemented in the vehicle. The controllers may be combined with each other and/or separated in any manner based on the particular type of electrical architecture that is desired in the vehicle. It is generally recognized that each controller and/or module/device disclosed may include, but not limited to, any number of microprocessors, ICs, memory devices (e.g., FLASH, RAM, ROM, EPROM, EEPROM, or other suitable variants thereof), and software which co-act with one another to perform the various functions set forth below.

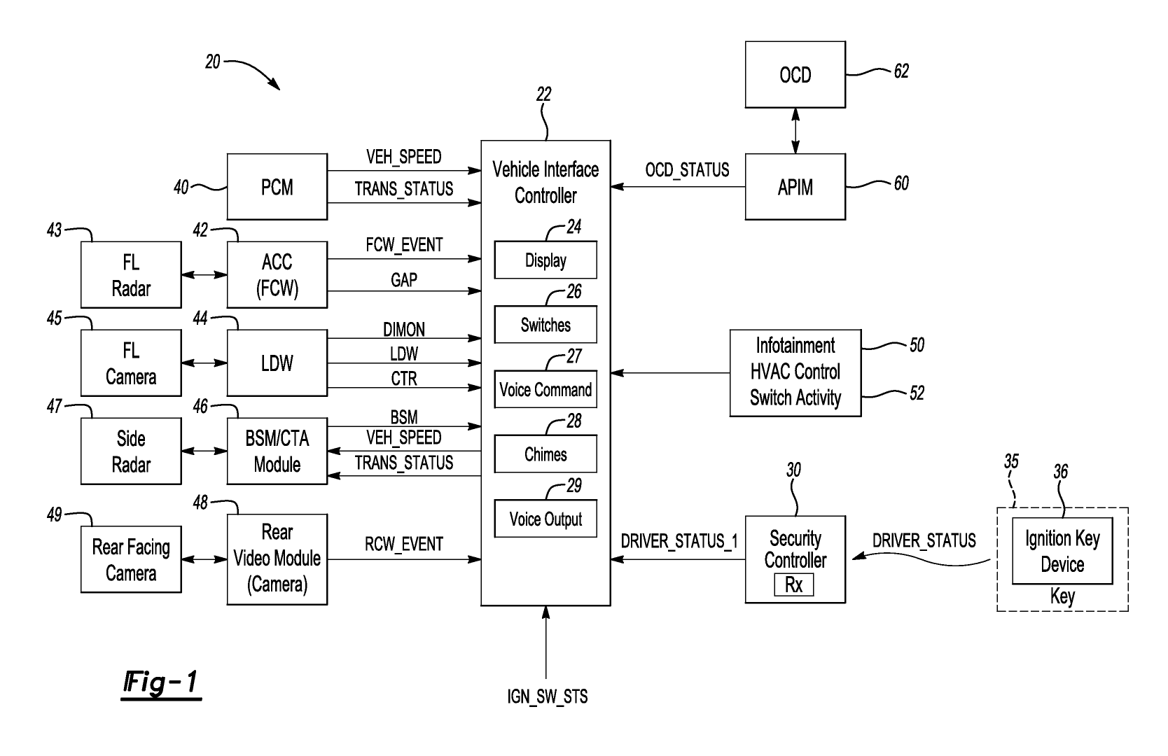

FIG. 1 depicts a system 20 for intelligently generating a space management (or “space”) alert to notify a driver of a possible collision with a vehicle or other object in accordance to one embodiment of the present invention. The system 20 generally comprises a vehicle interface device (or controller) 22. The controller 22 includes a display 24 that provides information related to the various states of vehicle functionality or visual warnings to the driver. For example, the display 24 may provide, but not limited to, a driver identification message during vehicle startup, various administrative menu options, a seatbelt warning message, a speed limit start up message, vehicle near top speed message, top speed message, driver identification speed warnings, one or more levels of visual warnings for tailgating and/or an inhibit electronic stability control (“ESC”) and forward collision warning (FCW) message and/or an alert to notify the driver that the vehicle is too close to another vehicle or object.

The controller 22 also includes a plurality of switches 26, a voice recognition command interface 27, chimes 28, and voice output capability 29. The driver may toggle the switches 26 to view different messages and/or select various options. The voice recognition command interface 27 may enable the vehicle to receive commands from the driver so that the driver may audibly input commands and/or responses. One example of a voice recognition command interface is disclosed in U.S. Patent Publication No. 20040143440 (“the '440 publication”), entitled “Vehicle Speech Recognition System”, filed Dec. 31, 2003.

The chimes 28 may audibly notify the driver when predetermined vehicle conditions have been met. In one example, the controller 22 may activate the chimes 28 when the vehicle is near a top speed, the vehicle has achieved a top speed, the vehicle has exceeded the top speed, there is a low level of fuel in the fuel tank, when the vehicle is detected to be too close to another vehicle or obstacle to prevent a collision and/or when the traction control is enabled. In one example, the voice output capability 29 enables the controller 22 to transmit audio signals to the driver in the manner, but not limited to, that described in the '440 publication. In one example, the switches 26 may be positioned within the display 24 such that the display 24 and the switches function as a touch screen. The switches 26 may be implemented as alpha-numeric characters. While the display 24, the switches 26, the voice input command interface 27, chimes 28, and the voice output capability 29 are shown within the controller 22, it is contemplated that one or more of these mechanisms may be positioned exterior to the controller 22.

A security controller 30 is operably coupled to the controller 22. While FIG. 1 generally illustrates that the security controller 30 is positioned outside of the controller 22, other implementations may include the security controller 30 being implemented directly within the controller 22. In general, one or more of the signals transmitted to/from the controller 22 may be transmitted via a data communication bus. The bus may be implemented as a High/Medium Speed Controller Area Network (CAN) bus, a Local Interconnect Network (LIN) bus or other suitable bus generally situated to facilitate data transfer therethrough. The particular type of bus used may be varied to meet the desired criteria of a particular implementation.

An ignition switch 34 (not shown) may receive one or more keys 35. The controller 22 may receive a signal IGN_SW_STS from a body controller (not shown) to determine the position of the ignition switch. The keys 35 may be tagged or associated with a primary driver or a secondary driver of the vehicle. The primary driver may be a parent, employer, or other suitable person who exercises complete control over the vehicle. The secondary driver may be a teenager, a valet, an employee, a technician or other person who must abide by vehicle parameters established by the primary driver. The key 35 includes an ignition key device 36 embedded therein for communicating with the vehicle. The ignition key device 36 comprises a transponder (not shown) having an integrated circuit and an antenna. The transponder is adapted to transmit an electronic code as a signal DRIVER_STATUS to a receiver (not shown) in the security controller 30. Data on the signal DRIVER_STATUS may be indicative of which driver (e.g., primary or secondary) is driving the vehicle. The signal DRIVER_STATUS may be in the form of radio frequency (RF) based signal or radio frequency identification (RFID) tag that corresponds to binary data. The security controller 30 determines if additional RF based data in the signal DRIVER_STATUS matches predetermined data stored therein (e.g., in a look up table of the security controller 30) prior to allowing the vehicle to start for anti-theft purposes. A powertrain control module (or engine controller) 40 allows the vehicle to start the engine in the event the RF based data matches the predetermined data.

The security controller 30 may transmit a signal DRIVER_STATUS _1 to indicate whether the particular driver is the primary driver or the secondary driver to various vehicle controllers or modules as either digital data or hardwired signals. Prior to the security controller 30 transmitting the signal DRIVER_STATUS_1, the primary and secondary keys must be learned to the PATS controller 30. The learning and programming of the keys 35 as either a primary or a secondary key is set forth in U.S. Pat. No. 7,868,759 (“the '759 patent”) to Miller et al., which is hereby incorporated by reference in its entirety. It is recognized that the security controller 30 may be a passive anti-theft controller as set forth in the '759 patent. It is also recognized that security controller 22 as set forth in FIG. 1 of the present disclosure may be implemented as a passive-entry-passive start (PEPS) controller as set forth in the '759 patent.

The powertrain control module (PCM) 40 is operably coupled to the controller 22. The controller 22 transmits an authorization signal (not shown) to the PCM 40 in response to determining that a key 35 is authorized to start the vehicle. The PCM 40 is configured to provide a signal VEH_SPEED over the data communication bus to the controller 22. The signal VEH_SPEED corresponds to the speed of the vehicle. The PCM 40 is also configured to provide a signal TRANS_STATUS over the data communication bus to the controller 22. The signal TRANS_STATUS corresponds to the transmission status of the vehicle (e.g., whether the vehicle is in Park, Neutral, Drive, Low).

A FCW module 42 is operably coupled to the device 22. The FCW module 42 is generally configured to determine whether a high probability exists for the vehicle to be on a path that leads to a forward collision (FC). One or more forward looking (FL) radars 43 are operably coupled to the controller 22. The FL radar 43 detects the presence/proximity of a vehicle (or object, obstacle, etc.) that may engage in a forward collision with the vehicle. The FL radar 43 transmits data indicative of the presence/proximity of the vehicle to the FCW module 42. In one example, the FCW module 42 may transmit a signal GAP which is indicative of the gap between the vehicle (i.e., the host vehicle) and another vehicle/object positioned ahead of the vehicle. The controller 22 generally issues space alerts (audible and/or visual) to the driver in the event the vehicle is detected to be too close to a vehicle ahead of the host vehicle if the data on the signal GAP exceeds a predetermined gap size. The alerts allow the driver to take corrective action by allowing the gap to increase. The controller 22 uses the signal GAP and/or other factors to determine whether the vehicle is maintaining a proper distance with respect to another vehicle. In another example, the ACC module 42 may process the gap information and transmit a signal FCW_EVENT to the controller 22 so that the controller 22 may trigger a forward collision alert warning/alert. The FCW alert is a more heightened alert as it is highly probable for the host vehicle to be on a path that leads to the FC. In contrast, the space alert corresponds to a point in which the host vehicle is detected to be too close to another vehicle/object (or proper space management between the host vehicle and another vehicle is not maintained). For example, the host vehicle may be tailgating with another vehicle.

A lane departure warning (LDW) module 44 is operably coupled to the controller 22. A forward looking (FL) camera 45 is operably coupled to the LDW module 44 to determine what side of the vehicle is deviating from a lane or crossing over the lane to issue a warning. The LDW module 44 transmits a signal LDW to the controller 22 for generating an audible and/or visual warning for the driver.

The LDW module 44 is also configured to detect a shift in the driver's performance that may cause the vehicle to leave a lane or head off of the road. For example, the LDW module 44 measures a Driver's Impairment Monitor (DIMON) and assigns a rating to it. The DIMON tracks vehicle variation within the lane. The DIMON may be a range that varies from a low value to a high value. The lower the value, the less the vehicle varies within the lane. The higher the value, the greater the vehicle varies within the lane. In general, the LDW module 44 monitors the DIMON to detect a shift in the driver's performance that may be attributed to the driver exhibiting a drowsy or sleepy condition. In one example, the LDW module 44 may transmit the DIMON value as the signal DIMON to the controller 22. The controller 22 may generate an alert if the DIMON rating exceeds a predetermined value. In another example, the LDW module 44 may store the predetermined value and determine whether the DIMON rating exceeds such a value. The LDW module 44 may transmit a signal CTR to control the controller 22 to generate the alert. The controller 22 may visually and/or audibly notify the driver that the vehicle is veering off of the road at an early stage so that the driver can regain control of the vehicle prior to collision or other failure mode.

A blind spot monitoring (BSM) and cross traffic alert (CTA) module 46 (“BSM module 46”) is operably coupled to the controller 22. One or more side radars 47 are operably coupled to the BSM module 46. The BSM module 46 is configured to determine whether a vehicle is in or entering into a location zone to either side (e.g., left or right side) of the vehicle based on information provided by the radar 47 (e.g., the radar 47 may include a radar positioned on a left rear corner of the vehicle and another radar positioned on a right rear corner of the vehicle). The location zone may be defined as the area extending rearward from exterior mirror of the vehicle to a minimum of at least three meters from beyond a bumper of the vehicle. The location zone may extend up to 1.5 lanes from either the right or the left side of the vehicle. The BSM module 46 provides an alert to the driver when the vehicle is overtaking a subject vehicle or is stagnating within the location zone. The BSM module 46 transmits a signal BSM to the controller 22 for generating a warning (e.g., audible and/or visual) to the driver. The warning is intended to notify the driver that a vehicle is located in the location zone of the host vehicle.

The BSM module 46 may also perform a cross-traffic alert (CTA) operation. For example, the signal BSM as generated by the BSM module 46 may be generated in the event vehicle is backing out of a parking spot and the side radar 47 detects that an on-coming vehicle is within the location zone. The BSM module 46 receives the signal VEH_SPEED and TRANS_STATUS from the controller 22 (or directly from the PCM 40) to ascertain the vehicle speed and the transmission status of the vehicle. The BSM module 46 ascertains the vehicle speed and the transmission status to perform the CTA operation. In one example, a threshold speed of 3 kph or above and the vehicle being in reverse may be used as pre-conditions to perform the CTA operation.

In general, the controller 22 uses the signal LDW and the signal BSM to monitor for space management events. For example, the LDW module 44 is configured to trigger and event if the vehicle departs from either a left or right side of the lane and the BSM module 46 provides an alert to notify the driver that a vehicle is in the location zone. The controller 22 uses such alerts to monitor for space management events.

A rear video module 48 may be operably coupled to the controller 22. One or more rear facing cameras 49 may be coupled to the rear video module 48 to determine the presence/proximity of a rearward positioned vehicle (or object, obstacle, etc.) with respect to vehicle. The controller 22 generally issues warnings (audible and/or visual) to the driver in the event the vehicle is detected to be on course or on a path that may lead to a rearward collision so that the driver can take corrective action. In the event the rear video module 48 detects that the vehicle is on a path that may lead to a rearward collision (or if a vehicle is rapidly approaching the vehicle from the rear), the rear video module 48 transmits a signal RCW_EVENT to the controller 22 for generating an alert. It is recognized that a rearward facing radar may be used in place of the camera to monitor the presence of a rearward positioned vehicle with respect to the vehicle.

An auxiliary protocol interface module (APIM) (or communication module) 60 is operably coupled to the controller 22. The APIM 60 is configured to receive an occupant communication device (OCD) 62. The OCD 62 may be a cell phone or other suitable communication mechanism. The APIM 60 is generally part of an in-vehicle communication system which interfaces with the OCD 62 to enable voice input control to perform a function with the OCD 62 so that the driver does not have to enter data directly into the OCD 62. The APIM 60 may interface via switches (not shown) positioned within the vehicle to enable touch selection control to perform a function with the OCD 62 so that the driver does not have to enter data directly into the OCD 62. The OCD 62 is wirelessly coupled to the APIM 60. In one example, the APIM 60 may be implemented as part of the SYNC system developed by Ford Motor Company® and Microsoft®. The OCD 62 may include any number of communication devices that use a wireless protocol. For example, one such wireless protocol may include Bluetooth™. The OCD 62 may use any protocol that is generally situated to facilitate wireless communication. Switches may be positioned on the APIM 60, the vehicle's steering wheel (not shown), or on the controller 22 to enable touch input. When the driver is utilizing the OCD 62 (i.e., if the OCD 62 is paired with the APIM 60), then the APIM 60 transmits a signal OCD_STATUS to notify the controller 22 that the driver is using the OCD 62. The relevance of this operation will be discussed in more detail below.

In general, the controller 22 is configured to assess information regarding space management of the host vehicle with respect to other vehicles/objects for one or more sides of the vehicle based on information received from at least one of the FCW module 42, LDW module 44, the BSM module 46, and the rear video module 48. The controller 22 may monitor the neighboring space around at least one side of the vehicle to determine when it is necessary to notify the driver that the host vehicle may be too close to a vehicle/object. The controller 22 determines whether (i) the vehicle is in a high density traffic condition (HDTC), (ii) the vehicle is in a cut-off or intentional merge condition (CIM), or (iii) the driver of the vehicle is distracted in order to efficiently generate alerts based on these conditions. By monitoring for these conditions, space alerts may be selectively generated in an attempt to ensure that the alerts are generated when warranted to ensure that the driver does not learn to ignore the alerts. Further, the controller 22 may issue different warning levels. This warning levels may be selectively generated as a means to coach for example a secondary driver or as a means to identify a condition which requires the driver (e.g., the primary driver or the secondary driver) to take immediate action.

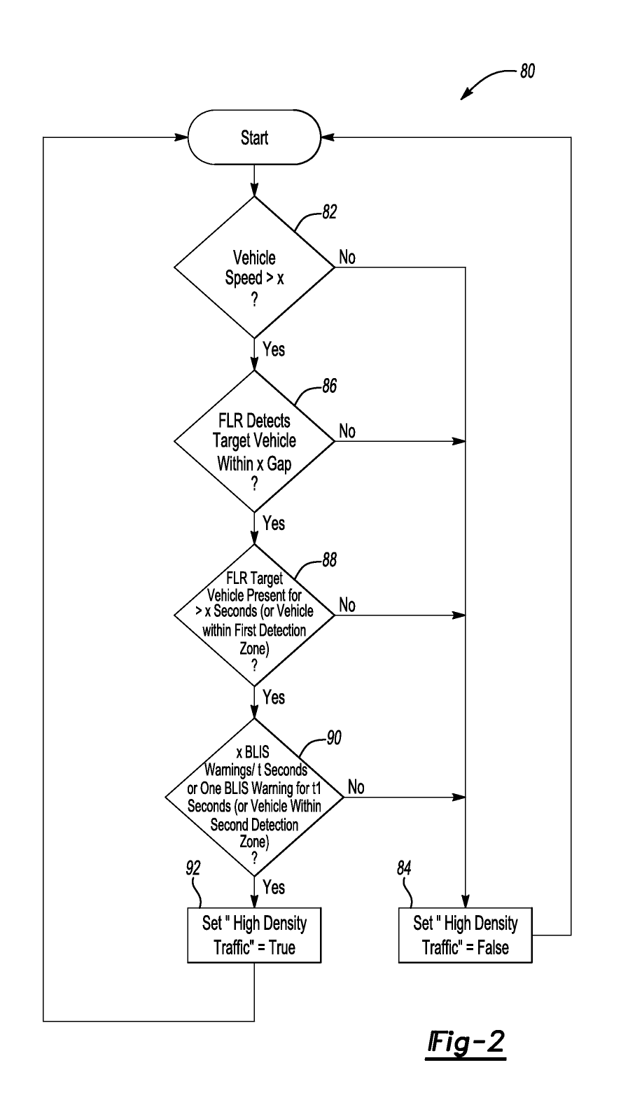

FIG. 2 depicts a method 80 for determining whether vehicle is in the HDTC in accordance to one embodiment. The particular order of the operations in the method 80 (or any other methods set for the herein) when performed, may be in any order and are not to be limited to only being performed sequentially. The order of the operations may be modified and vary based on the desired criteria of a particular implementation.

In operation 82, the controller 22 receives vehicle speed over the signal VEH_SPEED from the PCM 40. The controller 22 compares the received vehicle speed to a predetermined vehicle speed. If the received vehicle speed is less than the predetermined vehicle speed, then the method 80 moves to operation 84. If the received vehicle speed is greater than the predetermined vehicle speed, then the method 80 moves to operation 86.

In operation 84, the controller 22 determines that the vehicle is not in a HDTC and may generate a space alert unless other conditions warrant that such an alert is not needed. For example, the vehicle may be in CIM condition where it is not desirable to issue the alert.

In operation 86, the controller 22 determines whether the gap between the front of the host vehicle and a vehicle/object positioned ahead of the host vehicle is greater than the predetermined gap. In this operation, the controller 22 receives the signal GAP from the FCW module 42 to make this determination. If the gap is greater than the predetermined gap, then the method 80 moves to operation 84. If the gap is less than the predetermined gap, then the method 80 moves to operation 88.

In operation 88, the controller 22 monitors the amount of time that the host vehicle is detected to be below the predetermined gap. If the controller 22 determines that the gap between the host vehicle and the vehicle/object ahead of the host vehicle is less than the predetermined gap for a time period that is greater than a first predetermined time value, then the method 80 moves to operation 90. If operation 88 is true, such a condition is indicative of the controller 22 determining that the vehicle/object positioned in front of the host vehicle is in a first detection zone. If the above condition is not true such, then the method 80 moves to operation 84.

In operation 90, the controller 22 monitors the signal BSM (as received from the BSM module 46) to determine if one or more vehicles/objects are located within the detection zone with respect to the host vehicle and to monitor to amount of time such vehicle/objects are located within the detection zone. The controller 22 may monitor the time duration in which the signal BSM indicates that the vehicle or object (positioned on the side of the host vehicle) is detected to be in the detection zone. If the controller 22 determines that the host vehicle is in the detection zone for a period greater than the predetermined time period, then the method 80 moves to operation 92. If not, then the method 80 moves to operation 84. It is contemplated that if a vehicle is positioned on at least one side of the host vehicle within a predetermined timeframe or multiple vehicle are coming into at least one side of the host vehicle, then operation 90 may be true. If operation 90 is true, such a condition is indicative of the controller 22 determining that the vehicle/object positioned in front of the host vehicle is in a first detection zone.

In operation 92, the controller 22 determines that the vehicle is in HDTC. The controller 22 sets a flag indicating that this is the case. Operation 92 generally indicates that a vehicle/object positioned in front of the host vehicle is within the first detection zone and that the vehicle on at least one side of the host vehicle is within the second detection zone.

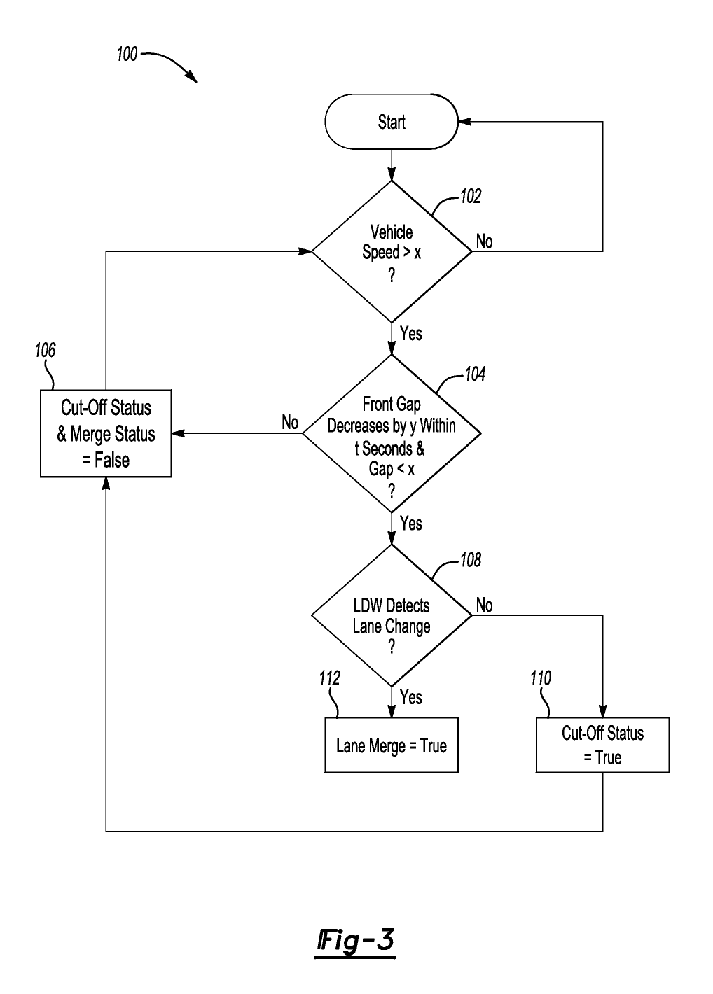

FIG. 3 depicts a method 100 for determining whether the vehicle is in a CIM condition in accordance to one embodiment of the present invention.

In operation 102, the controller 22 receives vehicle speed over the signal VEH_SPEED from the PCM 40. The controller 22 compares the received vehicle speed to a first predetermined vehicle speed. If the received vehicle speed is less than the first predetermined vehicle speed, then the method 100 remains in operation 102. If the received vehicle speed is greater than the first predetermined vehicle speed, then the method 100 moves to operation 104.

In operation 104, the controller 22 determines whether the gap between the host vehicle and a vehicle in front to the host vehicle exhibits a rapid rate of change (e.g., dgap/dt is greater than a predetermined value). If the gap did not undergo a rapid rate of change, then the method 100 moves to operation 106. If the gap did undergo a rapid rate of change, then the method 100 moves to operation 108.

In operation 106, the controller 22 determines that the vehicle is not in the CIM condition and may generate a distance alert unless other conditions warrant that such an alert is not needed. For example, the vehicle may be in HDTC where it is not desirable to issue the distance alert.

In operation 108, the controller 22 determines whether the subject vehicle is deviating from a lane or crossing over the lane which would be indicative of a lane change by monitoring the signal LDW. If the controller 22 does not determine that the subject vehicle is exhibiting a lane change, then the method 100 moves to operation 110. If the controller 22 determines that the subject vehicle is exhibiting a lane change, then the method 100 moves to operation 112.

In operation 110, the controller 22 determines that host vehicle is being cut-off by another vehicle.

In operation 112, the controller 22 determines that the vehicle is in the process of a lane merge.

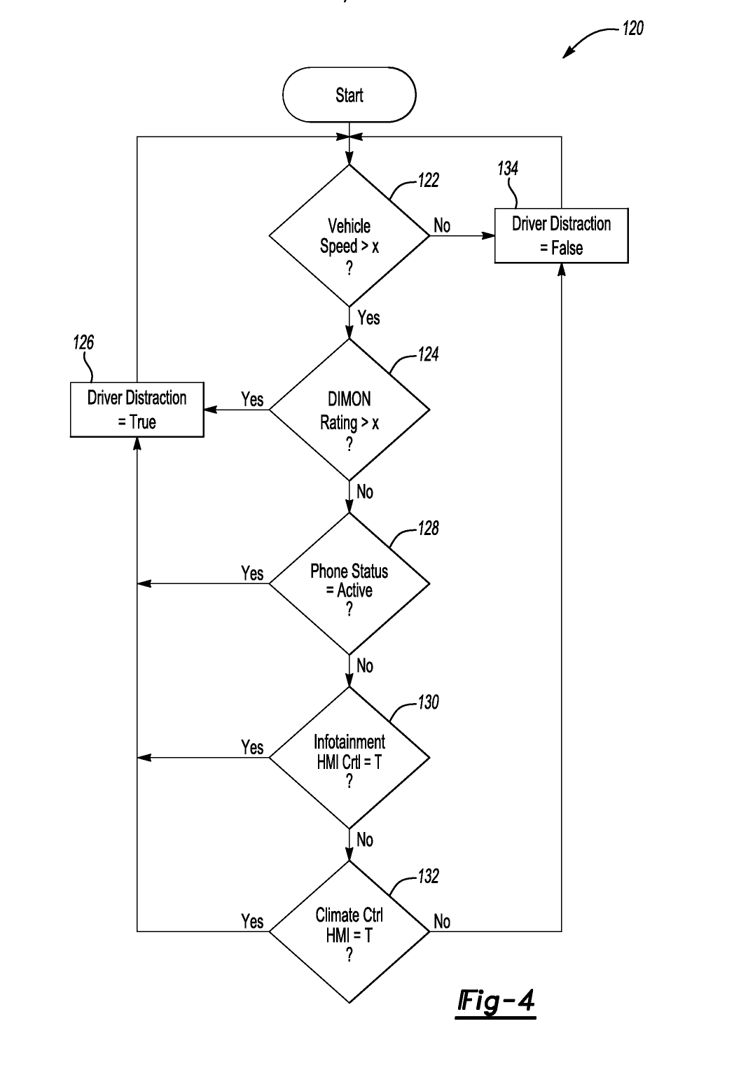

FIG. 4 depicts a method 120 for determining whether the driver is in a distracted state in accordance to one embodiment.

In operation 122, the controller 22 receives vehicle speed over the signal VEH_SPEED from the PCM 40. The controller 22 compares the received vehicle speed to a second predetermined vehicle speed. If the received vehicle speed is less than the second predetermined vehicle speed, then the method 120 moves to operation 134. If the received vehicle speed is greater than the second predetermined vehicle speed, then the method 120 moves to operation 124.

In operation 124, the controller 22 receives the signal DIMON to determine if the rating within the signal is above a first predetermined rating value. As noted above, the controller 22 monitors the signal DIMON to detect a shift in the driver's performance that may be attributed to the driver exhibiting a drowsy or sleepy condition. Such a condition may be indicative of a high DIMON rating. If the rating on the signal DIMON exceeds the predetermined rating value, then the method 120 moves to operation 126. The first predetermined rating value is generally the value or threshold when a warning is issued to the driver in the event the lane variation is such that an alert is required to be issued. If the rating on the signal DIMON does not exceed the first predetermined rating value, then the method 120 moves to operation 128. As noted above, the DIMON rating may be a value between a low and a high value. If the rating is weighted toward the lower end of the range (e.g., rating is below predetermined rating value), then an alert may not be issued unless secondary events are detected which are explained in the below operations (see operations 128, 130 and 132).

In operation 126, the controller 22 determines that the driver is distracted and sets a flag to indicate that the driver is distracted.

In operation 128, the controller 22 monitors phone status via the signal OCD_STATUS to assess if the driver is on the phone. If the controller 22 determines that the driver is using the OCD 62 such a condition may indicate that the driver is distracted. If this condition is true, then the method 120 moves to operation 126. If not, then the method 120 moves to operation 130.

In operation 130, the controller 22 monitors signal 50 which is indicative of the driver attempting to change aspects of an infotainment system (e.g., radio, CD, DVD, etc.) which may relate to, but not limited to, volume control, channel selection, etc. If the controller 22 determines that the driver is attempting to control the infotainment system, such a condition may indicate that the driver is in a distracted state. If the above condition is true, then the method 120 moves to operation 126. If not, then the method 120 moves to operation 132.

In operation 132, the controller monitors signal 52 which is indicative of the driver attempting to changes aspects of a climate control system (e.g., fan speed, temperature, defrost, etc.). If the controller 22 determines that the driver is attempting to control the climate control system, such a condition may indicate that the driver is in a distracted state. If the above condition is true, then the method 120 moves to operation 126. If not, then the method 120 moves to operation 134.

In operation 134, the controller 22 determines that the driver is not distracted.

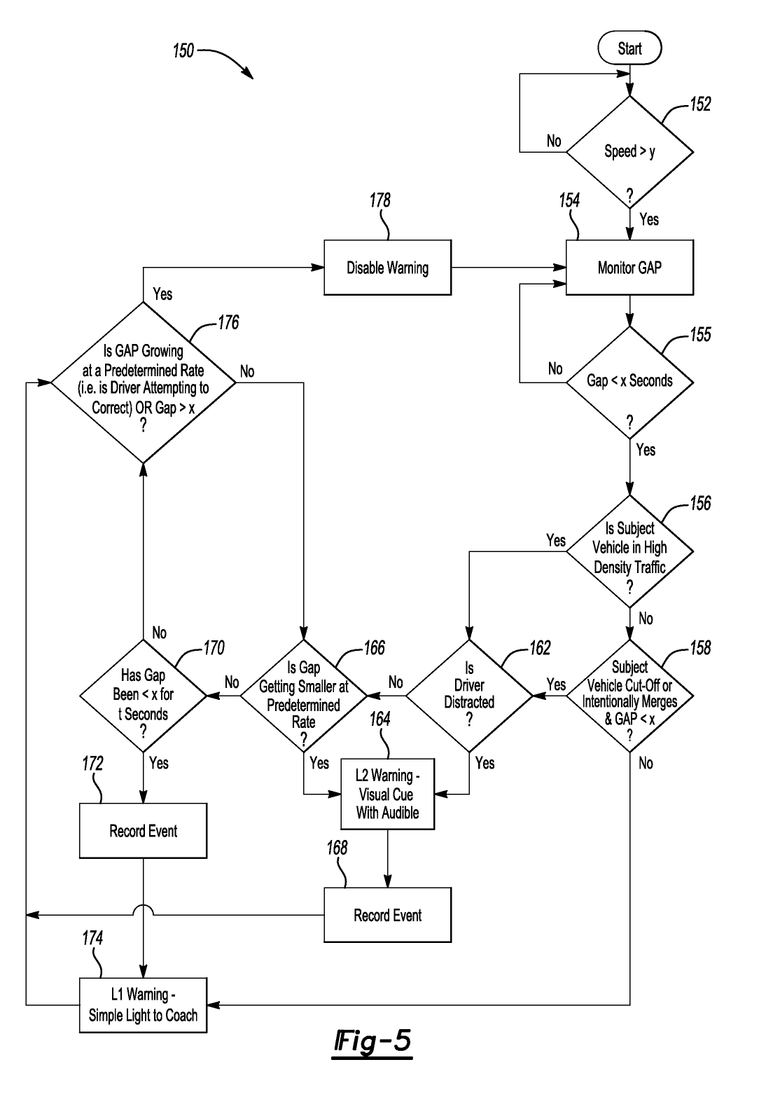

FIG. 5 depicts a method 150 for intelligently generating the distance alert to notify the driver of a proper space management with a vehicle or other object in accordance to one embodiment of the present invention.

In operation 152, the controller 22 determines the vehicle speed. If the vehicle speed is greater than a third predetermined vehicle speed, then the method 150 to operation 154. If not, the method 150 remains in operation 152.

In operation 154, the controller 22 monitors the gap between the host vehicle and another vehicle/object positioned in front of the host vehicle.

In operation 155, the controller 22 determines whether the gap is below a predetermined gap size. If the above condition is true, then the method 150 moves to operation 156. Prior to moving to operation 156, the controller 22 may set a flag indicating that the gap is decreasing over time. If the above condition is not true, then the method 150 moves to operation 154.

In operation 156, the controller 22 determines whether the vehicle is in the HDTC (see method 80 in connection with FIG. 2). If so, then the method 150 moves to operation 162. If not, then the method 150 moves to operation 158. It is recognized that it may not be desirable to generate an alert to notify the driver that the host vehicle may be too close to another vehicle/object if the vehicle is in the HDTC and no other condition warrants generating the alert.

In operation 158, the controller 22 determines whether the vehicle is in the CIM condition (see method 100 in connection with FIG. 3). If so, then the method 150 moves to operation 162. If not, then the method 150 moves to operation 174. In general, the CIM condition may identify small gaps due to the host vehicle being cut-off or the host vehicle intentionally squeezing into a gap to change lanes. While in the CIM condition, it may not be desirable to generate an alert at this point unless other conditions warrant generating an alert. The system 100 recognizes that it may be warranted to alert the driver with a simple visual warning in an effort to coach the driver in the CIM condition as will discussed below in connection with operation 174.

In operation 162, the controller 22 determines whether the driver is in a distracted state (see method 120 in connection with FIG. 4). If so, then the method 150 moves to operation 164. If not, then the method 150 moves to operation 166.

In operation 164, the controller 22 generates both an audible and a visual warning. The audible and visual warning may be the highest level warning issued to the driver. For example, in this situation, the vehicle is detected to be in the CIM condition or in the HDTC and at the same time be distracted. In this case, it may be desirable to generate both the audible and visual warning when the vehicle is detected to be in the CIM condition or in the HDTC and distracted to obtain the driver's attention.

In operation 168, the CIM condition and distracted state is recorded in the event the driver is detected to be the secondary driver. The controller 22 may record the event as set forth in co-pending PCT International Publication No. WO 2009/158469, filed on Jun. 25, 2009, which is hereby incorporated by reference in its entirety.

If the driver is not distracted as noted in operation 162, then the method 150 moves to operation 166. In operation 166, the controller 22 determines whether the gap between the host vehicle and the vehicle/object positioned ahead of the host vehicle is decreasing at a predetermined rate. If this condition is true, then the method 150 moves to operation 164 to audibly and visually generate the alert. If this condition is not true, then the method 150 moves to operation 170.

In operation 170, the controller 22 determines whether the host vehicle maintains a small gap between the host vehicle and the vehicle/object positioned ahead for a predetermined amount of time. If this condition is true, then the method 150 moves to operation 172. If not, then the method 150 moves to operation 176. This operation may allow the driver to correct his/her vehicle and may avoid the issuance of a warning, which could be a nuisance if indeed the driver corrects his/her vehicle by allowing the gap to increase.

In operation 172, the controller 22 records this event (this operation is optional or applies if the secondary driver is detected to be the driver of the vehicle). It may be desirable to record the event if the secondary driver has given the opportunity to correct the gap, but has failed to do so.

In operation 174, the controller 22 issues only a minor warning via a visual warning such as a simple light. The notion behind operations 170, 172 and 174 is to cover the situation where the driver is not distracted, but the driver is driving the host vehicle perhaps too close for a period of time with respect to the vehicle/object positioned ahead of the host vehicle. The visual warning may be used as a coaching tool to notify a driver (e.g., perhaps the secondary driver or a beginner driver) that the distance kept between the host vehicle and the vehicle/object ahead of the host vehicle is too close. The visual warning is intended to be less severe than the warning issued in operation 164.

In operation 176, the controller 22 determines whether the gap between the host vehicle and the vehicle/object ahead of the host vehicle increases or grows at a predetermined rate. In this case the driver may be attempting to leave a greater gap between the host vehicle and the vehicle/object ahead of the host vehicle. If this condition is true, then the method 150 moves to operation 178. If this condition is not true, then the method 150 moves to operation 166.

In operation 178, the controller 22 disables any existing warnings.

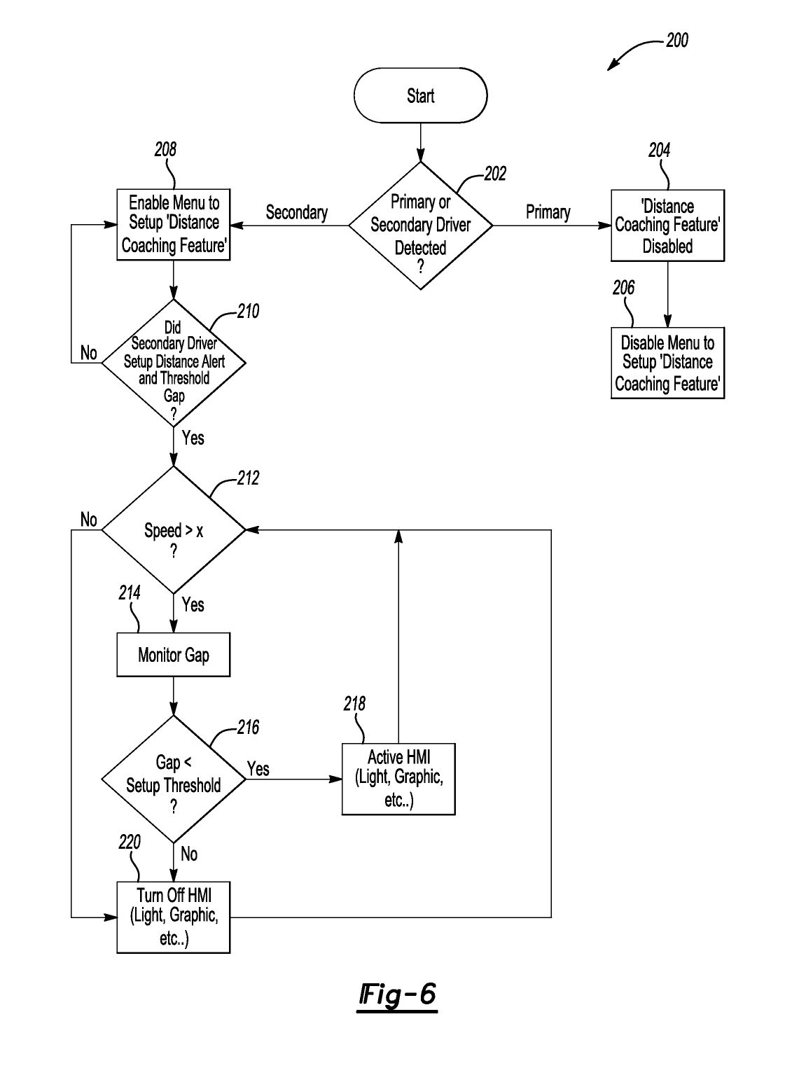

FIG. 6 depicts a method 200 for intelligently generating the alert to notify one of the primary driver and the secondary driver in accordance to one embodiment. It is recognized that the method 200 may be implemented with one or more operations noted in connection with the method 150.

In operation 202, the controller 22 determines whether the driver of the vehicle is the primary driver or the secondary driver in response to the signal DRIVER_STATUS_1. If the driver is the primary driver, then the method 200 moves to operation 204. If the driver is the secondary driver, then the method 200 moves to operation 208.

In operation 204, the controller 22 disables the “Distance Coaching Feature”. For example, the controller 22 may disable the visual warning as noted in connection with operation 174 of FIG. 5. The visual warning may be used as a coaching tool to educate a driver to keep the vehicle at a predetermined distance away from the vehicle/object in front of the vehicle to ensure that the driver is not tailgating with the front vehicle/object. The coaching feature aspect disclosed herein may be more applicable to the secondary driver who is a teen, employee, valet, or tech, etc. as opposed to the primary driver.

In operation 206, the controller 22 prevents the menu option from appearing to the primary driver to be used as a means to enable/disable the coaching feature.

In operation 208, the controller 22 enables the menu option to appear to the secondary driver such that the secondary driver can selectively turn on the coaching feature as desired in an effort to understand situations that may lead to the subject vehicle from being too close to another vehicle.

In operation 210, the controller 22 determines if the secondary driver has enabled the coaching feature. It is recognized that the secondary driver may have the option of not only enabling/disabling the coaching feature, but may also establish a front gap threshold for the vehicle via the controller 22. If this condition is true, then the method 200 moves to operation 212. If not, then the method 200 moves to back to operation 208.

In operation 212, the controller 22 determines the vehicle speed. If the vehicle speed is greater than a fourth predetermined vehicle speed, then the method 200 moves to operation 214. If not, the method 200 moves to operation 220.

In operation 214, the controller 22 monitors the front gap between the host vehicle and another vehicle/object.

In operation 216, the controller 22 determines whether the detected front gap is less than the front gap threshold as established in operation 210. If this condition is true, then the method 200 moves to operation 218. If not, then the method 200 moves to operation 220.

In operation 218, the controller 22 generates a visual indicator that the host vehicle has exceeded the threshold gap.

In operation 220, the controller 22 fails to generate a visual indicator.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. An apparatus for providing a space management alert for a host vehicle, the apparatus comprising:
a controller configured to:
determine whether a first vehicle positioned ahead of the host vehicle is in a first detection zone;
determine whether a second vehicle positioned on one of a left side and a right side of the host vehicle is in a second detection zone;
determine that the host vehicle is in a high density traffic condition (HDTC) if the first vehicle is in the first detection zone and the second vehicle is in the second detection zone; and
selectively disable the space management alert when the host vehicle is in the HDTC.

2. The apparatus of claim 1 wherein the first detection zone corresponds to the first vehicle being positioned within a predetermined gap of the host vehicle for a first time period that is greater than a first predetermined time value.

3. The apparatus of claim 2 wherein the second detection zone corresponds to the second vehicle being positioned within the one of the left side and the right side of the host vehicle for a second time period that is greater than a second predetermined time value.

4. The apparatus of claim 1 wherein the controller is further configured to monitor at least one signal to determine if the vehicle is in a distracted state.

5. The apparatus of claim 4 wherein the at least one signal corresponds to at least one of a Driver's Impairment Monitor (DIMON) signal which is indicative of the host vehicle's variation within a lane on a road, an occupant communication device (OCD) status signal which is indicative of whether a driver of the host vehicle is using an OCD, an infotainment signal which is indicative of the whether driver of the host vehicle is attempting to adjust a setting of an infotainment system, and a climate control signal which is indicative of whether the driver of the host vehicle is attempting to manipulate a setting related to a climate control system of the vehicle.

6. The apparatus of claim 4 wherein the controller is further configured to generate the space management alert if the host vehicle is in the HDTC and in the distracted state.

7. The apparatus of claim 1 wherein the controller is further configured to monitor a front gap between the host vehicle and the first vehicle and to determine whether the front gap has decreased for a time period that exceeds a predetermined time period.

8. The apparatus of claim 7 wherein the controller is further configured to generate the space management alert if the host vehicle is in the HDTC and if the front gap has decreased for a time period that exceeds the predetermined time period.

9. The apparatus of claim 1 further comprising a forward collision warning (FCW) system configured to transmit a gap signal indicative of a gap between the host vehicle and the first vehicle, the controller being configured to determine if the host vehicle is in the first detection zone based on at least the first signal.

10. The apparatus of claim 9 further comprising a blind spot monitoring (BMS) system configured to transmit a BSM signal indicating that the second vehicle is within a location zone of the host vehicle, the controller being configured to determine if the host vehicle is in the second detection zone based on at least the BSM signal.

11. A method comprising:
determining whether a first vehicle positioned ahead of a host vehicle is in a first detection zone and a second vehicle positioned on one of a left side and a right side of the host vehicle is in a second detection zone;
determining that the host vehicle is in a high density traffic condition (HDTC) if the first vehicle is in the first detection zone and the second vehicle is in the second detection zone; and
selectively disabling a space management alert when the host vehicle is in the HDTC.

12. The method of claim 11 wherein the first detection zone corresponds to the first vehicle being positioned within a predetermined gap of the host vehicle for a first time period that is greater than a first predetermined time value.

13. The method of claim 12 wherein the second detection zone corresponds to the second vehicle being positioned within the one of the left side and the right side of the host vehicle for a second time period that is greater than a second predetermined time value.

14. The method of claim 11 further comprising monitoring at least one signal to determine if the host vehicle is in a distracted state.

15. The method of claim 14 wherein the at least one signal corresponds to at least one of a Driver's Impairment Monitor (DIMON) signal which is indicative of the host vehicle's variation within a lane on a road, an occupant communication device (OCD) status signal which is indicative of whether a driver of the host vehicle is using an OCD, an infotainment signal which is indicative of the whether driver of the host vehicle is attempting to adjust a setting of an infotainment system, and a climate control signal which is indicative of whether the driver of the host vehicle is attempting to manipulate a setting related to a climate control system of the vehicle.

16. The method of claim 14 further comprising generating the space management alert if the host vehicle is in the HDTC and in the distracted state.

17. The method of claim 11 further comprising monitoring a front gap between the host vehicle and the first vehicle to determine whether the front gap has decreased for a time period that exceeds a predetermined time period in response to determining that the host vehicle is in the HDTC.

18. The method of claim 17 further comprising generating the space management alert if the host vehicle is in the HDTC and if the front gap has decreased for a time period that exceeds the predetermined time period.

19. An apparatus comprising:
a controller configured to:
receive a gap signal indicative of a front gap between a host vehicle and a first vehicle;
determine whether the front gap decreases over a predetermined time period;
determine that the host vehicle is experiencing a cutoff condition in response to the front gap decreasing over the predetermined time period; and
selectively disable transmitting a space management alert if the host vehicle is experiencing a cutoff condition.

20. The apparatus of claim 19 wherein the controller is further configured to receive a lane departure signal indicative of the host vehicle intentionally merging into another lane and the controller is further configured to selectively disable transmitting the space management alert if the host vehicle is intentionally merging into another lane.
